(19) United States
(12) Patent Application Publication
(10) Pub. No.: US 2005/0277562 A1
(43) Pub. Date: Dec. 15, 2005

(54) Compositions for cleaning and treating surgical devices

(76) Inventors: Erning Xia, Penfield, NY (US); Horngyih Huang, Penfield, NY (US); O. William Lever JR., Pittsford, NY (US); Wenyan Yan, Fairport, NY (US)

Correspondence Address: Bausch & Lomb Incorporated, One Bausch & Lomb Place, Rochester, NY, 14604-2701, US

(21) Appl. No.: 10/867,397

(22) Filed: Jun. 14, 2004

(51) Int. Cl. C11D 1/00

(52) U.S. Cl. 510/161

(57) ABSTRACT

Compositions and methods for cleaning surgical devices employing one or more phosphonates, one or more surfactants and one or more buffering agents in amounts effective to reduce elemental deposits on surgical devices are disclosed. Additionally, methods of making and using surgical device cleaning solutions containing one or more of the subject compositions are also disclosed.

### FIELD OF THE INVENTION

The present invention relates to compositions and methods for cleaning and treating surgical devices. More specifically, compositions of the present invention are particularly effective in the removal of rust, pits and stain from stainless steel ophthalmic surgical devices through an efficient process.

### BACKGROUND OF THE INVENTION

Until about twenty years ago, refractive errors of light passing through the eye could only be treated with spectacles or contact lenses, both of which have known disadvantages for the user. In the last several years, research has been directed to surgical procedures to change the refractive condition of the eye, e.g., to flatten or to increase the curvature of a patient's eye depending on the patient's particular condition. The desired result of such a surgical procedure is to have light rays passing through the cornea be refracted to converge properly and directly onto the retina of the eye so as to allow a patient to clearly see close or distant images.

One of several such surgical procedures to correct a refractive condition is automated lamellar keratectomy (ALK). ALK is a surgical procedure wherein the eye is first numbed by a drop of anesthetic and then a suction ring is placed on the eye to carefully position the cornea for being cut by a very fine microsurgical instrument known as a microkeratome. A microkeratome is a blade carrying device that is either manually pushed or mechanically driven in a cutting path across the suction ring simultaneous with the manual or motorized movement of the cutting element, which movement is transverse to the direction of the cutting path. The microkeratome is typically used to first cut into the cornea so as to raise and separate a thin layer of the anterior cornea of between 100 to 200 microns in thickness and about 7 mm in diameter. Next, the microkeratome is used to make a second pass over the cornea to resect or remove a smaller part of the cornea, generally about 4-6 mm in diameter, which is discarded. The anterior corneal cap which was cut away with the first pass of the microkeratome is then put back into its original position without suturing, for healing to occur. The desired result of this procedure is for the cornea to have a new curvature because of the resected tissue, which provides a new refractive surface to correct the patient's original myopic condition.

Known microkeratome surgical devices as described above include a housing for removably attaching a single-use only or single-patient only surgical cutting blade. To effectively clean microkeratome surgical cutting blades during and/or following manufacture thereof, solutions formulated for cleaning the blades having cleaning or removal effect over one or more stains are typically used. One such solution useful for cleaning metal substrates includes a phosphate-based product available commercially from Amity UK Ltd. under the trade name Orthoclean™.

Great importance is attached to the safety and efficacy of microkeratome surgical cutting blade cleaning solutions. While current cleaning solutions are safe and effective in cleaning microkeratome surgical cutting blades, improvements in cleaning solution safety and efficacy are sought.

U.S. Pat. No. 6,663,644 (Ross et al.), discloses a surgical cutting blade assembly for a microkeratome and uses thereof.

U.S. Pat. No. 4,903,695 (Warner et al.), discloses a method and apparatus for performing a keratomileusis or like surgical operations. The surgical operations include the use of a microkeratome set which includes a surgical cutting blade for use in cutting a lenticle from the remaining body of a cornea.

U.S. Pat. No. 6,051,009 (Hellenkamp et al.) discloses an automatic surgical device for cutting a cornea and a cutting blade assembly and control assembly. Noted in the patent is the importance of proper cleaning and sterilization of the microkeratome and blade assembly.

As mentioned above, commercially available cleaning agents are well known in the art of microkeratome surgical cutting blade cleaning. However independent use of commercially available cleaning solutions for cleaning microkeratome surgical cutting blades appears to have considerable limitations in cleaning effectiveness, and residue elemental films left behind after cleaning may cause ocular irritation. Accordingly, it would be desirable to find a surgical device cleaning solution effective in removing elemental films, rusts and stains without causing ocular irritation.

### SUMMARY OF THE INVENTION

All stainless steel surgical devices are required to undergo cleaning processes during and/or following the manufacture thereof. Most of such cleaning is to remove rust, pits and stain. The present invention provides safe and effective cleaning compositions for use in cleaning surgical devices or instruments. Compositions of the present invention and methods of using the same provide surgical device end users with better surgical performance and better customer satisfaction.

Elemental deposits are commonly found on the surface of surgical devices. The same is true even following cleaning of such devices using commercially available cleaners as described in more detail below in Example 3. Positively charged metal ions such as Fe³⁺, Ca²⁺ and the like, do not exist in a free state in aqueous solution. The complexation of metal ions by other ionic species is very important and useful in medical device industry such as surgical device cleaning and treatments. Also, this complexation or chelation can be applied to both removing potentially harmful metal ions and to providing needed or beneficial ions. Phosphonates such as for example but not limited to tetrasodium etidronate available under the trade name Dequest™ 2016 from Monsanto, St. Louis, Mo., used in combination with citrates have been found to have superior cleaning effectiveness. Citrate ions in compositions of the present invention serve as both chelating agents and buffers or a buffer system to ensure the quality of sequestration/chelating and deflocculation/dispersion within a stable pH environment. The suitable range of pKa's of citric acid for use in compositions of the present invention is from about 3 to about 7. The subject buffered phosphonate and surfactant formulations are valuable for their effectiveness in removing elemental deposits of rust and other oxides from steel surfaces. Such are also very efficient in removing complex of calcium carbonate from water and metal oxide from steel. An added benefit of the phosphonate-based cleaning solutions of the present invention is the simultaneous metal passivation that occurs which is described in more detail below.

The subject phosphonate-based compositions are safe and effective for the cleaning and treatment of surgical devices. Additionally, the subject phosphonate-based compositions are biocompatible and cause little or no tissue irritation.

Accordingly, it is an object of the present invention to provide a composition useful in the cleaning of surgical devices.

Another object of the present invention is to provide a method for using a phosphonate-based composition in solution to clean surgical devices.

Another object of the present invention is to provide a composition useful in the treatment of surgical devices.

Another object of the present invention is to provide a method for using a phosphonate-based composition in solution to treat surgical devices.

Another object of the present invention is to provide a biocompatible composition useful for cleaning ophthalmic surgical cutting blades.

Still another object of the present invention is to provide a method for the production of biocompatible compositions useful for cleaning ophthalmic surgical cutting blades.

These and other objectives and advantages of the present invention, some of which are specifically described and others that are not, will become apparent from the detailed description and claims that follow.

### BRIEF DESCRIPTION OF THE DRAWINGS

FIG. 1 is a photograph of a microkeratome surgical cutting blade with manufacturing residue film; and

FIG. 2 is a photograph of the microkeratome surgical cutting blade of FIG. 1 after cleaning with compositions of the present invention.

### DETAILED DESCRIPTION OF THE INVENTION

Compositions of the present invention may be used with all surgical devices such as for example but not limited to scalpels, microkeratome cutting blades, trocars, suture needles, and the like manufactured from stainless steel, aluminum, copper, ceramic and like rigid materials.

Compositions employed in this invention are aqueous solutions. The compositions include, as an essential component, one or more phosphonates, such as those disclosed in U.S. Pat. No. 5,858,937 (Richards et al.), which include hydroxyalkylphosphonates. Suitable phosphonates for use in compositions of the present invention include for example but are not limited to the Dequest™ line of products available from Monsanto, St. Louis, Mo. The preferred phonphonate for use in compositions of the present invention is tetrasodium etidronate available under the trade name Dequest™ 2016 (Monsanto). Phosphonates are present in the subject compositions in a total amount of from approximately 0.001 to approximately 10.0 percent by weight based on the total weight of the composition, but more preferably from about 0.1 to about 1.0 percent by weight.

Compositions of the present invention likewise include one or more surfactants having known advantages in terms of cleaning efficacy and biocompatibility. Surfactants are present in the subject compositions in a total amount of from approximately 0.001 to approximately 25.0 percent by weight based on the total weight of the composition, but more preferably from about 0.1 to about 5.0 percent by weight. Suitable surfactants include for example but are not limited to polyethers based upon poly(ethylene oxide)-poly(propylene oxide)-poly(ethylene oxide), i.e., (PEO-PPO-PEO), or poly(propylene oxide)-poly(ethylene oxide)-poly(propylene oxide), i.e., (PPO-PEO-PPO), or a combination thereof. PEO-PPO-PEO and PPO-PEO-PPO are commercially available under the trade names Pluronics™, R-Pluronics™, Tetronics™ and R-Tetronics™ (BASF Wyandotte Corp., Wyandotte, Mich.) and are further described in U.S. Pat. No. 4,820,352 incorporated herein in its entirety by reference. Another suitable surfactant for use in the present invention is an anionic surfactant available under the trade name Avanel™ (BASF Wyandotte Corp.). Suitable surfactants for use in the present composition should be soluble in the cleaning solution, not become turbid, and should be biocompatible, or non-irritating to tissues. Surfactants function in the present invention as cleaning agents, dispersion agents and viscosity adjusting agents. Suitable surfactant polymers remove stains or rust, and lifts and/or disperses particulate matter in the cleaning solution following deflocculation. The surfactant polymers also provide a cushioning film on the surface of surgical devices following cleaning thereof. Such cushioning film prevents direct contact between surgical devices, such as microkeratome surgical cutting blades, during manufacturing procedures.

Compositions of the present invention likewise include one or more conventional buffers employed to obtain the desired pH value. Generally the desired pH value will range between about 2 to about 12. Suitable buffers include for example but are not limited to borate buffers based on boric acid and/or sodium borate, phosphate buffers based on Na₂HPO₄, NaH₂PO₄ and/or KH₂PO₄, citrate buffers based on sodium or potassium citrate and/or citric acid, sodium bicarbonate, aminoalcohol buffers and combinations thereof. Generally, buffers will be used in amounts ranging from about 0.05 to about 2.5 weight percent, and preferably, from about 0.1 to about 1.5 weight percent.

Compositions of the present invention may optionally also contain various other components including for example but not limited to one or more chelating and/or sequestering agents, one or more osmolality adjusting agents, and/or one or more wetting agents.

Chelating agents are also referred to as sequestering agents. These agents bind heavy metal ions, which might otherwise react with the surgical device and collect thereon. Chelating agents are well known in the art, and examples of preferred chelating agents include ethylenediaminetetraacetic acid (EDTA) and its salts, especially disodium EDTA. Such agents are normally employed in amounts from about 0.01 to about 2.0 weight percent, more preferably from about 0.01 to about 0.3 weight percent. Other suitable sequestering agents include gluconic acid, citric acid, tartaric acid and their salts, e.g., sodium salts.

Compositions of the present invention may be designed for a variety of osmolalities. Osmotic values less than about 600 mOsm/Kg are generally desirable. One or more osmolality adjusting agents may be employed in the composition to obtain the desired final osmolality. Examples of suitable osmolality adjusting agents include, but are not limited to sodium and potassium chloride, monosaccharides such as dextrose, calcium and magnesium chloride, and low molecular weight polyols such as glycerin and propylene glycol. Typically, these agents are used individually in amounts ranging from about 0.01 to 5 weight percent and preferably, from about 0.1 to about 2 weight percent.

The subject compositions may likewise optionally include a wetting agent, to facilitate the composition wetting the surface of a surgical device. Within the art, the term “humectant” is also commonly used to describe these materials. A first class of wetting agents are polymer wetting agents. Examples of suitable wetting agents include for example but are not limited to poly(vinyl alcohol) (PVA), poly(N-vinylpyrrolidone) (PVP), cellulose derivatives and poly(ethylene glycol). Cellulose derivatives and PVA may be used to also increase viscosity of the composition, and offer this advantage if desired. Specific cellulose derivatives include for example but are not limited to hydroxypropyl methyl cellulose, carboxymethyl cellulose, methyl cellulose, hydroxyethyl cellulose, and cationic cellulose derivatives. Suitable cationic cellulosic polymers include for example but are not limited to water soluble polymers commercially available under the CTFA (Cosmetic, Toiletry, and Fragrance Association) designation polyquaternium-10, including the cationic cellulosic polymers available under the trade name UCARE® Polymers from Amerchol Corp., Edison, N.J. Generally, these cationic cellulose polymers contain quaternized N,N-dimethylamino groups along the cellulosic polymer chain.

Another suitable class of wetting agents is non-polymeric wetting agents. Examples include glycerin, propylene glycol, and other non-polymeric diols and glycols.

The specific quantities of wetting agents used in the present invention will vary depending upon the application. However, the wetting agents will typically be included in an amount from about 0.01 to about 5 weight percent, preferably from about 0.1 to about 2 weight percent.

It will be understood that some constituents possess more than one functional attribute. For example, cellulose derivatives are suitable polymeric wetting agents, but are also referred to as “viscosity increasing agents” to increase viscosity of the composition if desired. Glycerin is a suitable non-polymeric wetting agent but is also may contribute to adjusting tonicity.

As an illustration of compositions of the present invention, several examples are provided below. These examples serve only to further illustrate aspects of the invention and should not be construed as limiting the invention.

### EXAMPLE 1

### Preparation of Test Solutions For One-Step Cleaning Analysis

Sample solutions for testing were prepared in accordance with the formulations set forth below in Table 1.

TABLE 1
TEST SOLUTIONS

| Ingredients | Test Solution | | | |
|---|---|---|---|---|
| % W/W | 1 | 2 | 3 | 4 |
| Sodium Citrate | 0.90 | 3.60 | 0.90 | 0.90 |
| Citric Acid | 1.00 | 4.00 | 1.00 | 1.00 |
| Dequest 2016 (30%) | 0.10 | 0.40 | 0.10 | 0.10 |
| Pluronic F38 | 2.00 | 8.00 | 0 | 0 |
| Pluronic F127 | 0 | 0 | 1.00 | 2.00 |
| Purified Water | Q.S. to 100 gm | | | |
| pH | 3.5-4.5 | 3.5-4.5 | 4.00 | 4.00 |
| Osmolality (Osmo/Kg) | 100-220 | 600-900 | 180-220 | 180-220 |
| One-Step Cleaning result | E | ND | AA | E |
| Ingredients | Test Solution | | | |
| % W/W | 5 | 6 | 7 | 8 |
| Sodium Citrate | 0.70 | 0.70 | 1.50 | 2.50 |
| Citric Acid | 0.80 | 0.80 | 1.67 | 2.77 |
| Dequest 2016 (30%) | 0.10 | 0.10 | 0.10 | 0.10 |
| Pluronic F38 | 0 | 0 | 0 | 0 |
| Pluronic F127 | 1.00 | 2.00 | 2.00 | 2.00 |
| Purified Water | Q.S. to 100 gm | | | |
| pH | 6.00 | 6.00 | 4.00 | 4.00 |
| Osmolality (Osmo/Kg) | 180-220 | 180-220 | 180-220 | 210-250 |
| Cleaning result | A | A | E | E |

ND = No data
E = Excellent
AA = Above average
A = Average

Microkeratome blades were cleaned using the above-identified test solutions in a one-step cleaning procedure. The same cleaning procedure was used for each of the test solutions, which entailed soaking microkeratome blades in the particular test solution for a specified period of time and evaluating the level of cleaning efficacy achieved. The results obtained from this one-step cleaning procedure are set forth in Table 1 above.

### EXAMPLE 2

### Preparation of Test Solutions For Two-Step Cleaning Analysis

Sample solutions for testing were prepared in accordance with the formulations set forth below in Table 2.

TABLE 2
TEST SOLUTIONS

| Ingredients | Test Solution | | | |
|---|---|---|---|---|
| % W/W | 9A | 9B | 10A | 10B |
| Sodium Citrate | TBD | 2.50 | 2.50 | 0 |
| Citric Acid | TBD | 2.77 | 2.80 | 0 |
| Sodium Bicarbonate | 0 | 0 | 0 | 0.2-2.0 |
| Dequest 2016 (30%) | 0.10 | 0.10 | 0.10 | 0 |
| Pluronic P123 | 0.1-0.3 | 0 | 0 | 0 |
| Pluronic F127 | 0 | 2.00 | 0 | 0 |
| Avanel S70 | 0 | 0 | 1.00 | 0 |
| Purified Water | Q.S. to 100 gm | | | |
| pH | 3-5 | 4-6 | 3.5-4.5 | 8-12 |
| Osmolality (Osmo/Kg) | 180-220 | 210-250 | 180-220 | 180-220 |
| Two-Step Cleaning result | A | E | AA | E |

ND = No data
E = Excellent
AA = Above average
A = Average

Microkeratome blades were cleaned using the above-identified test solutions in a two-step cleaning procedure. The same cleaning procedure was used for both of the test solutions identified, which entailed soaking microkeratome blades in the particular test solution with a relatively low pH for a specified period of time and then soaking the microkeratome blades in the same test solution with a relatively higher pH for a specified period of time. For example, Test solution 10 A is used as the first step in the two-step cleaning procedure. Test solution 10A includes an anionic surfactant with a relatively lower pH. Test solution 10B is used as the second step in the two-step cleaning procedure. Test solution 10B has a relatively higher pH. The results obtained from this two-step cleaning procedure using test solutions 9A/B and 10A/B are set forth in Table 2 above.

### EXAMPLE 3

### Commercial Cleaning Solution Cleaned Microkeratome Surgical Cutting Blade Surface Analysis

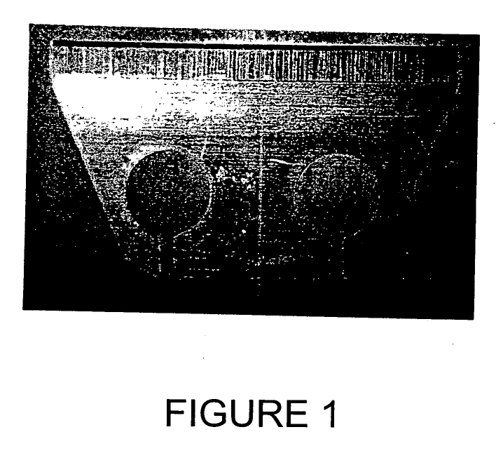

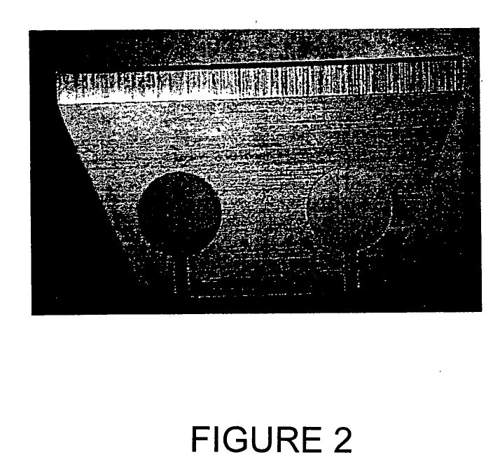

Hansatome™ (Bausch & Lomb Incorporated, Rochester, N.Y.) microkeratome surgical cutting blades (Lot Number 581781) were cleaned using a one-step cleaning procedure in a commercially available phosphate-based cleaning solution suitable for cleaning metal substrates (Group 1). Other Hansatome™ (Bausch & Lomb Incorporated, Rochester, N.Y.) microkeratome surgical cutting blades (Lot Number 581781) were cleaned using a one-step cleaning procedure in Test Solution 6 of the present invention (Group 2). FIG. 1 is a photograph of one of the subject Group 2 blades prior to cleaning. FIG. 2 is a photograph of one of the subject Group 2 blades following cleaning in Test Solution 6. The Control microkeratome blades were not cleaned. After cleaning (Groups 1 and 2), the blades were handled with clean stainless steel tweezers and set up on clean aluminum platens. The blades were held in place by means of clean screws and washers against the top of the sample platen. The edges of the blades were suspended over a void, such that only the blade edge was in the instrument analysis plane. In this manner, the blades were all analyzed. Each of the blades were analyzed at five positions along both sides of the edge.

The Physical Electronics [PHI] Model 5600 XPS was utilized for X-ray photoelectron spectroscopy (XPS) analysis. This instrument operates a monochromatized aluminum anode operated at 300 watts, 15 kV and 20 milliamps. The base pressure of the instrument was 2.0×10⁻⁹ torr and during operation the pressure was typically 5.0×10⁻⁸ torr. Since the blades were conductive, no neutralization was needed. All data was taken over 800 micron areas. This instrument made use of a hemispherical analyzer. The instrument had a personal computer (PC) workstation with PHI PC Access software. Assuming the inelastic mean free path for a carbon 1s photoelectron is 35 angstroms, the practical measure for sampling depth for this instrument at a sampling angle of 45 degrees is approximately 75 angstroms. The governing equation for sampling depth in XPS is d=3λ sin θ, where “d” is the sampling depth, “λ” is the photoelectron inelastic mean free path and “θ” is the angle formed between the sample surface and the axis of the analyzer.

Each blade was analyzed utilizing a low-resolution survey spectra (0-1100 eV) to identify the elements present on the sample surface. Quantification of elemental compositions was completed by integration of the photoelectron peak areas. Analyzer transmission, photoelectron cross-sections and source angle correction were taken into consideration in order to give accurate atomic concentration values. XPS analysis data is set forth below in Table 3.

TABLE 3
XPS Atomic Concentration Data
(Blade Lot Number 581781)

| | | C | N | O | P | Cl | Cr | Fe | Fe/Cr |
|---|---|---|---|---|---|---|---|---|---|
| Control | Avg. | 43.5 | 1.6 | 45.4 | 0.0 | 0.3 | 0.3 | 8.9 | 26.5 |
| (n = 6) | Std. Dev. ± | 3.0 | 0.6 | 2.5 | 0.0 | 0.2 | 0.3 | 1.4 | |
| Group 1 | Avg. | 32.5 | 0.3 | 49.8 | 0.9 | 0.0 | 5.8 | 10.6 | 1.8 |
| (n = 6) | Std. Dev. ± | 1.3 | 0.5 | 0.9 | 0.3 | 0.0 | 0.4 | 0.5 | |
| Group 2 | Avg. | 28.7 | 0.2 | 51.5 | 0.4 | 0.0 | 9.3 | 9.8 | 1.1 |
| (n = 6) | Std. Dev. ± | 1.2 | 0.4 | 0.6 | 0.4 | 0.0 | 0.4 | 1.3 | |

Avg. = Average
n = Sample Size
Std. Dev. = Standard deviation
C = Carbon
N = Nitrogen
O = Oxygen
P = Phosphorous
Cl = Chlorine
Cr = Chromium
Fe = Iron

The XPS results revealed that elements detected on the blade surfaces included iron, chromium, carbon, oxygen, nitrogen and phosphorous. The Fe/Cr ratio for Control blades was consistently lower (chromium rich) than the cleaned blades. This could be the result of iron being removed during the cleaning process.

Compositions of the present invention may be used for soaking a surgical device whereby the aqueous composition comprises one or more phosphonates, one or more surfactants and one or more buffers present in amounts effective to reduce and/or remove elemental deposits from the surface of such surgical device.

Compositions of the present invention may also be used for rinsing a surgical device whereby the aqueous composition comprises one or more phosphonates, one or more surfactants and one or more butters present in amounts effective to reduce or remove elemental deposits from surfaces of such surgical device.

Still another method of using compositions of the present invention comprises preventing deposition of elemental deposits on a surgical device following cleaning of such surgical device. This method comprises soaking the surgical device in an aqueous composition with one or more phosphonates, one or more surfactants and one or more buffers present in amounts effective to prevent deposition of elemental deposits on the surface of such surgical device, and continuing with manufacturing or production procedures without rinsing the composition from the surgical device.

Although various preferred embodiments have been illustrated, many other modifications and variations of the present invention are possible to the skilled practitioner. It is therefore understood that, within the scope of the claims, the present invention can be practiced other than as herein specifically described.

1. Compositions for cleaning surgical devices comprising:
an effective amount of one or more phosphonates;
an effective amount of one or more surfactants; and
an effective amount of one or more buffering agents.

2. The composition of claim 1 wherein said one or more phosphonates are selected from the group consisting of hydroxyalkylphosphonates.

3. The composition of claim 1 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

4. The composition of claim 1 wherein said one or more buffering agents are selected from the group consisting of borate buffers, phosphate buffers, citrate buffers, sodium bicarbonate, aminoalcohol buffers and combinations thereof.

5. The composition of claim 1, wherein the composition further comprises at least one member selected from the group consisting of one or more chelating agents, one or more osmolality adjusting agents, and one or more wetting agents.

6. The composition of claim 5, wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

7. The composition of claim 5 wherein said one or more osmolality adjusting agents are selected from the group consisting of sodium chloride, potassium chloride, monosaccharides, calcium chloride, magnesium chloride, and low molecular weight polyols.

8. The composition of claim 5 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

9. The composition of claim 1 wherein the composition comprises about 0.001 to about 10.0 weight percent of said one or more phosphonates and about 0.001 to about 25.0 weight percent of said one or more surfactants.

10. A method of removing elemental deposits from surgical devices comprising:
soaking a surgical device in a solution of one or more compositions including an effective amount of one or more phosphonates, one or more surfactants and one or more buffering agents.

11. A method of cleaning surgical devices comprising:
rinsing a surgical device in a solution of one or more compositions including an effective amount of one or more phosphonates, one or more surfactants and one or more buffering agents.

12. The method of claim 10 or 11 wherein said one or more phosphonates are selected from the group consisting of hydroxyalkylphosphonates.

13. The method of claim 10 or 11 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

14. The method of claim 10 or 11 wherein said one or more buffering agents are selected from the group consisting of borate buffers, phosphate buffers, citrate buffers, sodium bicarbonate, aminoalcohol buffers and combinations thereof.

15. The method of claim 10 or 11 wherein the composition further comprises at least one member selected from the group consisting of one or more chelating agents, one or more osmolality adjusting agents, and one or more wetting agents.

16. The method of claim 15 wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

17. The method of claim 15 wherein said one or more osmolality adjusting agents are selected from the group consisting of sodium chloride, potassium chloride, monosaccharides, calcium chloride, magnesium chloride, and low molecular weight polyols.

18. The method of claim 15 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

19. The method of claim 10 or 11 wherein the composition comprises about 0.001 to about 10.0 weight percent of said one or more phosphonates and about 0.001 to about 25.0 weight percent of said one or more surfactants.

20. A method of producing a surgical device cleaning solution comprising:
combining one or more phosphonates, one or more surfactants and one or more buffering agents in amounts effective for reducing elemental deposits on surgical devices.

21. The method of claim 20 wherein said one or more phosphonates are selected from the group consisting of hydroxyalkylphosphonates.

22. The method of claim 20 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

23. The method of claim 20 wherein said one or more buffering agents are selected from the group consisting of borate buffers, phosphate buffers, citrate buffers, sodium bicarbonate, aminoalcohol buffers and combinations thereof.

24. The method of claim 20 wherein the solution further comprises combining at least one member selected from the group consisting of one or more chelating agents, one or more osmolality adjusting agents, and one or more wetting agents.

25. The method of claim 24 wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

26. The method of claim 24 wherein said one or more osmolality adjusting agents are selected from the group consisting of sodium chloride, potassium chloride, monosaccharides, calcium chloride, magnesium chloride, and low molecular weight polyols.

27. The method of claim 24 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

28. The method of claim 20 wherein the composition comprises about 0.001 to about 10.0 weight percent of said one or more phosphonates and about 0.001 to about 25.0 weight percent of said one or more surfactants.

29. An aqueous composition for treating or cleaning surgical devices comprising:
an effective amount of one or more phosphonates;
an effective amount of one or more surfactants; and
an effective amount of one or more buffering agents; to reduce deposits on the surface of the surgical device.

30. The composition of claim 29 wherein said one or more phosphonates are selected from the group consisting of hydroxyalkylphosphonates.

31. The composition of claim 29 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

32. The composition of claim 29 wherein said one or more buffering agents are selected from the group consisting of borate buffers, phosphate buffers, citrate buffers, sodium bicarbonate, aminoalcohol buffers and combinations thereof.

33. The composition of claim 29, wherein the composition further comprises at least one member selected from the group consisting of one or more chelating agents, one or more osmolality adjusting agents, and one or more wetting agents.

34. The composition of claim 29, wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

35. The composition of claim 29 wherein said one or more osmolality adjusting agents are selected from the group consisting of sodium chloride, potassium chloride, monosaccharides, calcium chloride, magnesium chloride, and low molecular weight polyols.

36. The composition of claim 29 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

37. The composition of claim 29 wherein the composition comprises about 0.001 to about 10.0 weight percent of said one or more phosphonates and about 0.001 to about 25.0 weight percent of said one or more surfactants.

38. A cleaned surgical device with a phosphorous atomic concentration value less than about 0.5.

39. A cleaned surgical device with a carbon atomic concentration value less than about 30.0.

40. The surgical device of claim 38 or 39 wherein said device is a microkeratome blade.

41. A surgical device cleaned using a solution comprising:
an effective amount of one or more phosphonates;
an effective amount of one or more surfactants; and
an effective amount of one or more buffering agents.

42. A microkeratome blade cleaned using a solution comprising:
an effective amount of one or more phosphonates;
an effective amount of one or more surfactants; and
an effective amount of one or more buffering agents

43. The surgical device of claim 41 wherein said one or more phosphonates are selected from the group consisting of hydroxyalkylphosphonates.

44. The surgical device of claim 41 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

45. The surgical device of claim 41 wherein said one or more buffering agents are selected from the group consisting of borate buffers, phosphate buffers, citrate buffers, sodium bicarbonate, aminoalcohol buffers and combinations thereof.

46. The surgical device of claim 41, wherein the solution further comprises at least one member selected from the group consisting of one or more chelating agents, one or more osmolality adjusting agents, and one or more wetting agents.

47. The surgical device of claim 46, wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

48. The surgical device of claim 46 wherein said one or more osmolality adjusting agents are selected from the group consisting of sodium chloride, potassium chloride, monosaccharides, calcium chloride, magnesium chloride, and low molecular weight polyols.

49. The surgical device of claim 46 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

50. The surgical device of claim 41 wherein the solution comprises about 0.001 to about 10.0 weight percent of said one or more phosphonates and about 0.001 to about 25.0 weight percent of said one or more surfactants.

51. The microkeratome blade of claim 42 wherein said one or more phosphonates are selected from the group consisting of hydroxyalkylphosphonates.

52. The microkeratome blade of claim 42 wherein said one or more surfactants are selected from the group consisting of polyethers based upon poly(ethylene oxide)-poly(propylene oxide)-poly(ethylene oxide), poly(propylene oxide)-poly(ethylene oxide)-poly(propylene oxide) or a combination thereof.

53. The microkeratome blade of claim 42 wherein said one or more buffering agents are selected from the group consisting of borate buffers, phosphate buffers, citrate buffers, sodium bicarbonate, aminoalcohol buffers and combinations thereof.

54. The microkeratome blade of claim 42, wherein the solution further comprises at least one member selected from the group consisting of one or more chelating agents, one or more osmolality adjusting agents, and one or more wetting agents.

55. The microkeratome blade of claim 54, wherein said one or more chelating agents are selected from the group consisting of ethylenediaminetetraacetic acid, salts of ethylenediaminetetraacetic acid, gluconic acid, salts of gluconic acid, citric acid, salts of citric acid, tartaric acid and salts of tartaric acid.

56. The microkeratome blade of claim 54 wherein said one or more osmolality adjusting agents are selected from the group consisting of sodium chloride, potassium chloride, monosaccharides, calcium chloride, magnesium chloride, and low molecular weight polyols.

57. The microkeratome blade of claim 54 wherein said one or more wetting agents are selected from the group consisting of poly(vinyl alcohol), poly(N-vinylpyrrolidone), cellulose derivatives and poly(ethylene glycol), glycerin, propylene glycol, non-polymeric diols and non-polymeric glycols.

58. The microkeratome blade of claim 42 wherein the solution comprises about 0.001 to about 10.0 weight percent of said one or more phosphonates and about 0.001 to about 25.0 weight percent of said one or more surfactants.
